(19) United States
(12) Patent Application Publication
(10) Pub. No.: US 2018/0121944 A1
(43) Pub. Date: May 3, 2018

(54) USER DATA CURRENCY NORMALIZATION

(71) Applicant: INTERNATIONAL BUSINESS MACHINES CORPORATION, ARMONK, NY (US)

(72) Inventor: Robyn R. Schwartz, Deerfield, IL (US)

(21) Appl. No.: 15/342,195

(22) Filed: Nov. 3, 2016

(51) Int. Cl. G06Q 30/02

(52) U.S. Cl. CPC G06Q 30/0208

(57) ABSTRACT

An approach is provided for determining a value of data. After determining that a user's computing device is performing an action which generates data specifying the user's associated content, preferences, traits, behavior, or location, and that the data is of interest to entity(ies), the value of the data is assessed and normalized. The entity(ies) are determined to be offering reward(s) for sharing the data. The reward(s) are determined to have monetary value(s) that each equals or exceeds the normalized value. The normalized value and the reward(s) are displayed. A selection of one of the displayed reward(s) is received. The selected reward is offered by one of the entity(ies). The data is shared with a computing device of the entity that offered the reward and if a reward was selected, the reward is sent to the computing device of the user.

### BACKGROUND

The present invention relates to determining a value of user-provided data, and more particularly to determining an offer that is transparently comparable in value to a normalized value of user-provided data.

Users willingly or often unknowingly (i.e., without purposeful intention) provide data through their mobile devices and electronic interactions. With increased media attention to data thievery and malicious acts, users will likely begin to habitually suppress the provision of their data. For example, the Data Protection Act in the United Kingdom provides individuals with the right to prevent their personal data being processed for direct marketing. Consumer data has become a kind of currency which is traded and sold among various enterprises in support of such things as dynamic and personalized marketing campaigns. Current technology collects physical and behavioral data and self-authored and peer-authored content about a user and data analytics uses the collected data to predict consumer behavior and drive consumer behavior to a positive outcome. One example of using the aforementioned collected data is to offer consumers an improved customer experience. Business entities derive top-line and bottom-line value through the aforementioned data, including, but not limited to: improved conversion, improved advocacy, improved operations, velocity-based monetization through resell or continual re-use, lowered cost to sell, improved forecasting, prognostic business operations management, etc. Users are not knowledgeable participants in a realization of the value of the data they provide.

### SUMMARY

In one embodiment, the present invention provides a method of determining a value of data. The method includes a computer determining that (i) a computing device of a user is performing an action included in a predefined plurality of actions, (ii) in response to a completion of the action, the action generates the data which specifies content authored at least in part by the user or which specifies a preference, a trait, a behavior, or a location of the user, and (iii) the data is in a category of data for which one or more computing devices of one or more entities have sent an indication of interest. The method further includes the computer automatically assessing the value of the data. The method includes the computer normalizing the value of the data. The method further includes the computer determining that the one or more entities are offering one or more rewards to the user for a sharing of the data. The method further includes the computer determining that the one or more rewards have respective one or more monetary values that each equals or exceeds the normalized value of the data. The method further includes based on the one or more rewards having the one or more monetary values that each equals or exceeds the normalized value of the data, the computer initiating a display of the normalized value of the data and the one or more rewards. The method further includes the computer receiving a selection of a reward included in the displayed one or more rewards. The selection of the reward is received from the computing device of the user. The selected reward is offered by an entity included in the one or more entities. The method further includes based on the selection of the reward having been received, the computer sharing the data with a computing device of the entity that offered the reward and if the reward was selected, sending the reward to the computing device of the user or another computing device of the user.

In another embodiment, the present invention provides a computer program product including a computer-readable storage device and a computer-readable program code stored in the computer-readable storage device. The computer-readable program code includes instructions that are executed by a central processing unit (CPU) of a computer system to implement a method of determining a value of data. The method includes the computer system determining that (i) a computing device of a user is performing an action included in a predefined plurality of actions, (ii) in response to a completion of the action, the action generates the data which specifies content authored at least in part by the user or which specifies a preference, a trait, a behavior, or a location of the user, and (iii) the data is in a category of data for which one or more computing devices of one or more entities have sent an indication of interest. The method further includes the computer system automatically assessing the value of the data. The method includes the computer system normalizing the value of the data. The method further includes the computer system determining that the one or more entities are offering one or more rewards to the user for a sharing of the data. The method further includes the computer system determining that the one or more rewards have respective one or more monetary values that each equals or exceeds the normalized value of the data. The method further includes based on the one or more rewards having the one or more monetary values that each equals or exceeds the normalized value of the data, the computer system initiating a display of the normalized value of the data and the one or more rewards. The method further includes the computer system receiving a selection of a reward included in the displayed one or more rewards. The selection of the reward is received from the computing device of the user. The selected reward is offered by an entity included in the one or more entities. The method further includes based on the selection of the reward having been received, the computer system sharing the data with a computing device of the entity that offered the reward and if the reward was selected, sending the reward to the computing device of the user or another computing device of the user.

In another embodiment, the present invention provides a computer system including a central processing unit (CPU); a memory coupled to the CPU; and a computer-readable storage device coupled to the CPU. The storage device includes instructions that are executed by the CPU via the memory to implement a method of determining a value of data. The method includes the computer system determining that (i) a computing device of a user is performing an action included in a predefined plurality of actions, (ii) in response to a completion of the action, the action generates the data which specifies content authored at least in part by the user or which specifies a preference, a trait, a behavior, or a location of the user, and (iii) the data is in a category of data for which one or more computing devices of one or more entities have sent an indication of interest. The method further includes the computer system automatically assessing the value of the data. The method includes the computer system normalizing the value of the data. The method further includes the computer system determining that the one or more entities are offering one or more rewards to the user for a sharing of the data. The method further includes the computer system determining that the one or more rewards have respective one or more monetary values that each equals or exceeds the normalized value of the data. The method further includes based on the one or more rewards having the one or more monetary values that each equals or exceeds the normalized value of the data, the computer system initiating a display of the normalized value of the data and the one or more rewards. The method further includes the computer system receiving a selection of a reward included in the displayed one or more rewards. The selection of the reward is received from the computing device of the user. The selected reward is offered by an entity included in the one or more entities. The method further includes based on the selection of the reward having been received, the computer system sharing the data with a computing device of the entity that offered the reward and if the reward was selected, sending the reward to the computing device of the user or another computing device of the user.

Embodiments of the present invention increase a user's knowledge of the value of data about user-authored or peer-authored content or about the user's preferences, traits, behavior, and physical location and increase the likelihood that the user will agree to provide the data via a transparent generation of a normalized value of the data.

### BRIEF DESCRIPTION OF THE DRAWINGS

FIG. 1 is a block diagram of a system for determining and normalizing a value of user data and determining an offer whose value is comparable to the normalized value, in accordance with embodiments of the present invention.

FIG. 2 is a flowchart of a process for determining and normalizing a value of user data and determining an offer whose value is comparable to the normalized value, where the process is implemented in the system of FIG. 1, in accordance with embodiments of the present invention.

FIG. 3 is an example of determining and normalizing a value of user data and determining an offer whose value is comparable to the normalized value, which utilizes the process of FIG. 2, in accordance with embodiments of the present invention.

FIG. 4 is an example of a data value matrix utilized in the example of FIG. 3, in accordance with embodiments of the present invention.

FIG. 5 is a block diagram of a computer that is included in the system of FIG. 1 and that implements the process of FIG. 2, in accordance with embodiments of the present invention.

### DETAILED DESCRIPTION

### Overview

Embodiments of the present invention recognize that many users do not understand the value of user data that is generated via electronic transactions or other actions performed by a user's interaction with a mobile device or other computing device and that is submitted by the user voluntarily or without purposeful intention. Known data collection and analytics techniques collect user-authored or co-authored content (i.e., content that may be authored about a user with or without knowledge or participation of that user) and physical and behavioral data about users to offer an improved user experience as a customer without allowing the user to be a fully knowledgeable participant in a system of exchange based on the monetary value of the data. Behavioral data can include such activities as: physical clickstream behavior, virtual clickstream behavior, redundant physical and virtual patterns, abnormal physical or virtual patterns, transactions, requests (e.g., requests to a software-based intelligent personal assistant, knowledge navigator, smart speaker, or home automation hub), or participation within a group or network and subsequent or associated physical or virtual behavior. Users who gain a limited awareness of their data having monetary value and who realize that known systems do not allow fully knowledgeable participation in the sharing of the data may respond by suppressing the sharing of their data.

Embodiments of the present invention facilitate a virtual system of exchange by normalizing at an atomic level the value of real-time, behavioral, user-authored, and voluntarily submitted user data for a single transaction or for multiple transactions in aggregate over a time period and transparently providing the normalized value to users. The user data can also include data involuntarily provided by the user with or without an awareness of the user about the data being provided. The user data can also include data provided by one or more people other than the user, where the data is linked to the user with or without an awareness of the user about the data being provided and linked by the one or more other people. The normalized value of the data about a user allows the user to dynamically receive an inherent value of user data to facilitate an evaluation of whether an offer from a business or other entity provides comparable value, where the offer is for exchanging a sharing of the data for a reward from the business or other entity. The normalized value of the user data provides a currency that can be applied immediately for conversion to obtain comparable return value from the business or other entity making the offer. The normalized value of the user data also allows the user to knowledgeably negotiate counter-offers, thereby increasing the likelihood that the user will participate in the exchange that includes sharing the user data with the business or other entity. The aforementioned generation and use of the normalized value may be incorporated into existing web app-based techniques by which a user negotiates a price for the user's personal data, thereby improving the web app-based techniques by providing the user with a normalized view of the value that the user data has to entities interested in utilizing or reselling the user data, which facilitates negotiation in an exchange for the user data with an understanding by all parties involved in the exchange of the actual value of the user data and what reward offered for the user data has value comparable to the actual value of the user data.

### SYSTEM FOR DETERMINING A VALUE OF USER DATA

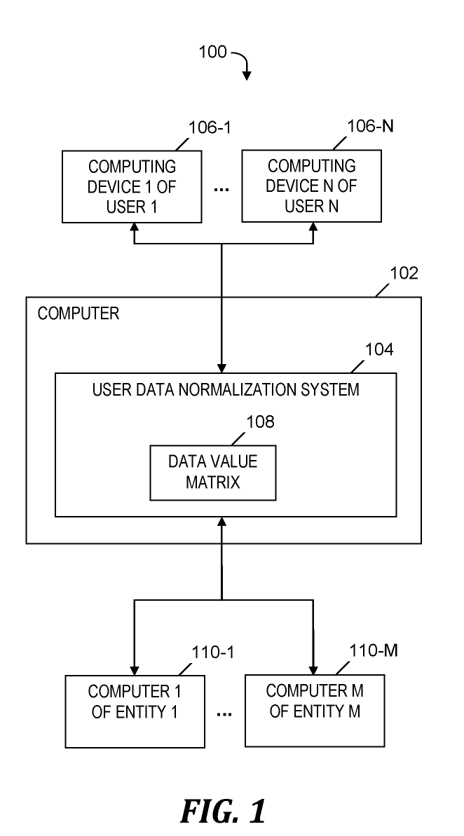

FIG. 1 is a block diagram of a system 100 for determining and normalizing a value of user data and determining an offer whose value is comparable to the normalized value, in accordance with embodiments of the present invention. System 100 includes a computer 102 which executes a software-based user data normalization system 104. In one embodiment, computer 102 is a mobile device such as a smartphone.

User data normalization system 104 is in communication via a computer network (not shown) with one or more computing devices 106-1, . . . , 106-N of respective User 1, . . . , User N, where N is an integer greater than or equal to one. User data normalization system 104 receives from computing device 106-1 an indication that computing device 106-1 is performing an action (e.g., an electronic commerce transaction) whose completion results in a generation of data (i.e., user data) that specifies a trait, a behavior, or a location of User 1. User data normalization system 104 generates a data value matrix 108 which includes assessed values of the data being generated by the aforementioned action. User data normalization system 104 generates a normalized value from the assessed value.

User data normalization system 102 is in communication via a computer network (not shown) with computer 110-1, . . . , computer 110-M of respective Entity 1, . . . , Entity M, where M is an integer greater than or equal to one. User data normalization system 102 determines that a reward offered by Entity 1 for the aforementioned user data has a monetary value and determines whether the normalized value is greater than or equal to the monetary value of the reward. The monetary value may be a (1) value of a single use of the user data, (2) a value of multiple uses of the user data based on a number of uses of the user data, or (3) a fixed value for multiple uses of the user data with no limitations on the number of uses. User data normalization system 102 may also determine a cumulative value consisting of the normalized value of the user data added to one or more normalized values of other user data generated as a result of one or more other, previous actions performed by the computing device of the user, and determine whether the cumulative value is greater than or equal to the monetary value of the reward.

Computing device 106-1 receives and displays the reward, the monetary or barter value of the reward, the normalized value, and the cumulative value, which presents User 1 with a transparent view of the monetary value of the reward and whether the monetary value of the reward is comparable to the normalized value of the user data or the cumulative value of the user data. In one embodiment, the reward is a barter. As used herein, a barter is an exchange presumed to be fair by the participants involved in the exchange. The participants may be consumers/users and formalized business entities. The participants may also be socially derived entities functioning in a business fashion (i.e., for gain). The socially derived entities can be individuals or networks or groupings of users working in digital and/or physical environments. In one embodiment, the barter is an exchange between participants in a social network or in another grouping in a digital environment.

Based on the user's selection of the reward or an acceptance by Entity 1 of a counter-offer of the user which modifies the reward and/or modifies usage parameters specifying how the user data may be used by an entity with whom the user data is shared, user data normalization system 104 shares the user data with computer 110-1 of Entity 1 and sends the selected reward (or the modified reward if the user made a counter-offer and the counter-offer was accepted by Entity 1) to computing device 106-1 of User 1. The reward received by computing device 106-1 is remuneration to User 1 for usage of the user data either internally by Entity 1 or by Entity 1 reselling the user data to another entity.

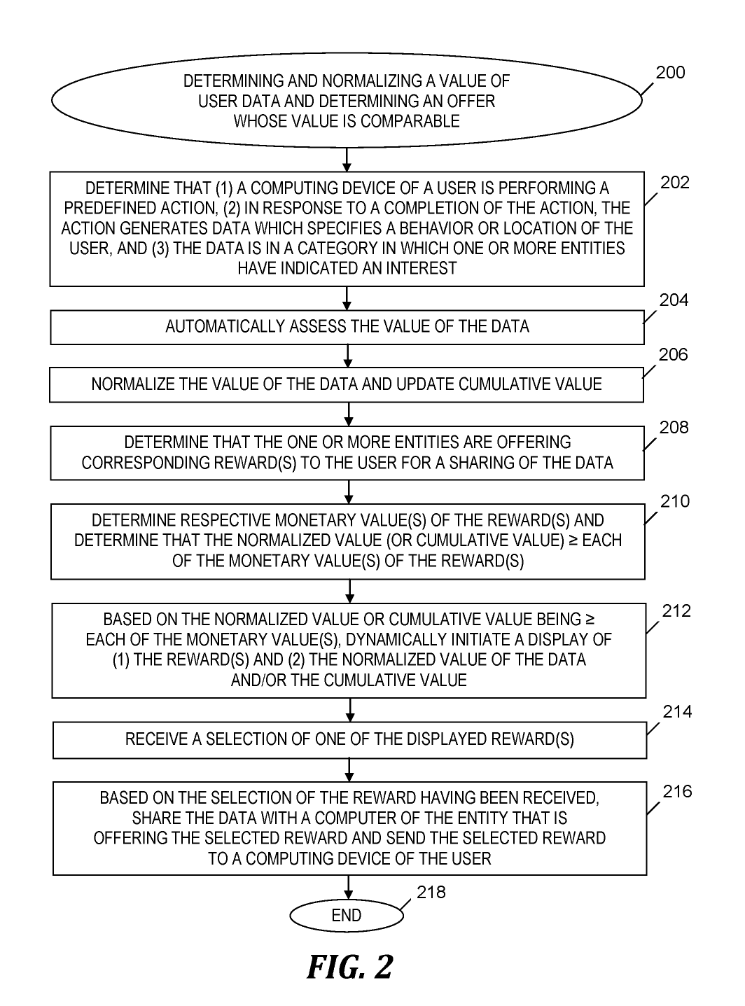

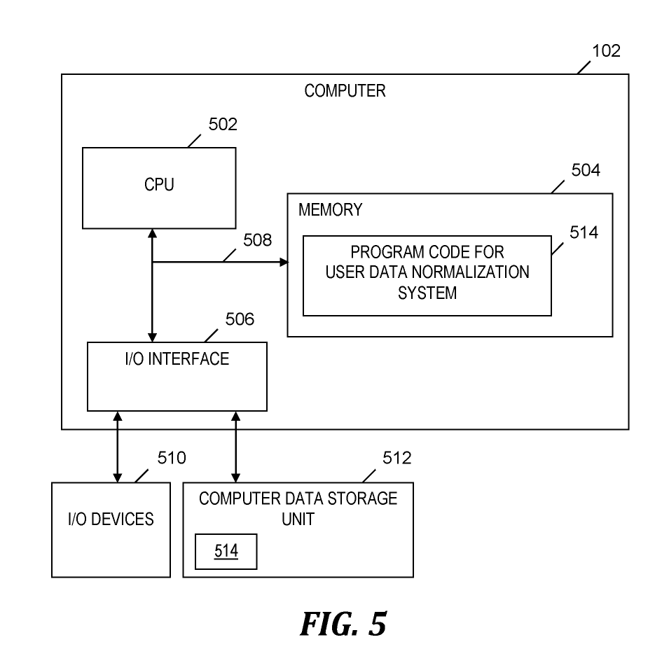

The functionality of the components shown in FIG. 1 is described in more detail in the discussion of FIG. 2 and FIG. 5 presented below.

### PROCESS FOR DETERMINING A VALUE OF USER DATA

FIG. 2 is a flowchart of a process for determining and normalizing a value of user data and determining an offer whose value is comparable to the normalized value, where the process is implemented in the system of FIG. 1, in accordance with embodiments of the present invention. The process of FIG. 2 starts at step 200. In step 202, user data normalization system 104 (see FIG. 1) determines that (1) a computing device of a user is performing an action (e.g., an e-commerce transaction) which is included in a predefined set of actions; (2) in response to a completion of the action, the action generates data which specifies content authored at least in part by the user or which specifies a preference, a trait, a behavior, or a location of the user; and (3) the data is in a category included in specified categories of data, where the one or more entities (e.g., businesses) have sent, via respective computing device(s), an indication of interest in using data in the specified categories. Hereinafter, in the discussion of FIG. 2, the aforementioned data which specifies a trait, a behavior, or a location of a user is referred to as “the data” or “user data.”

In one or more embodiments, the user data includes data specifying a user's behavior and/or geographical location, which results from a user's computing device accessing the Internet via a particular computer network (e.g., wireless local area network) and a wireless access point, accessing particular client software that accesses a service made available by a server, accessing categories of content and particular content presented by a web application or other software, making a payment during an electronic commerce transaction, utilizing a promotional offer during an electronic commerce transaction, posting the user's feedback or other content authored by the user via an online social media or social networking service, etc.

In one or more embodiments, the user data includes information describing a particular user (e.g., name, age, market segment, plan type, etc.), physical or contextual information about the user accessed from a customer data record (CDR), a physical behavioral pattern of the user derived from aggregate CDR information, the clickstream behavioral pattern of the user derived from aggregate CDR information, situational information including topics in which the user is interested as indicated by websites visited via the computing device of the user, transactional information including the user's personal taste preferences, transactional information including the user's payment activity via the computing device, the network activity of the computing device of the user, and aggregate situational information including access by the user's computing device of peer-to-peer and social networks.

Prior to step 202, user data normalization system 104 (see FIG. 1) receives usage parameters specifying the limitations and requirements for an entity using the user data shared with the entity. Prior to step 202, user data normalization system 104 (see FIG. 1) receives categories of user data for which the one or more entities are interested in making offer(s) of reward(s) in exchange for the user sharing the user data. In one embodiment, the reward(s) include barter(s). Prior to step 202, user data normalization system 104 (see FIG. 1) receives the set of actions which are specified by the one or more entities as being actions that result in a generation of user data which is in one of the aforementioned categories which are of interest to the one or more entities.

In step 204, user data normalization system 104 (see FIG. 1) automatically assesses the value of the user data. The value assessed includes a combination of (1) an internal calculated value of the user data generated by the action whose performance was determined in step 202, where the internal calculated value is associated with exactly one instance of a direct, internal usage of the user data by an entity; (2) an internal calculated value of the user data generated by the action whose performance was determined in step 202, where the internal calculated value is associated with multiple instances of a direct, internal usage of the user data by an entity; (3) a resell calculated value of the user data generated by the action whose performance was determined in step 202, where the resell calculated value is associated with exactly one instance of a first entity reselling the user data to a second entity, and where the first entity does not internally use the user data; and (4) a resell calculated value of the user data generated by the action whose performance was determined in step 202, where the resell calculated value is associated with multiple instances of a first entity reselling the user data to one or more other entities, and where the first entity does not internally use the user data.

In step 206, user data normalization system 104 (see FIG. 1) normalizes the value of the data which was assessed in step 204 and updates a cumulative value of the user data and other user data generated as a result of the computing device of the user performing one or more other, previous actions included in the predefined set actions. The normalized value of the user data is determined at an atomic level, which determines both top-line and bottom-line potential impact of the user data on the business or other entity, either by direct internal use of the user data by the business or other entity or by reselling the user data to another entity. The potential impact of the user data on the business or other entity may include improving a cost of selling, sales forecasting, product development, etc., to improve the cost of goods sold, while also improving trade fund efficiencies, product innovation and development, etc., which improves top-line revenue.

In one embodiment, step 206 utilizes profitability metrics across product, customer, or channel to determine a valuation of the user data. Step 206 may include user data normalization system 104 (see FIG. 1) determining baseline profitability by first calculating a baseline case of not including any user data currency (e.g., calculate the case of no personalized promotion where offers are made at expected or pre-planned rates using only known metrics for product profitability). Subsequently, user data normalization system 104 (see FIG. 1) calculates the value of including the user data currency and compares the calculated value to the baseline case. In one embodiment, the calculated value is based on user profitability considered as an average profit-incoming rate per transaction in aggregate for the user. User data normalization system 104 (see FIG. 1) may also use the historical customer-specific or segment-specific conversion rate and the channel visit frequency to calculate the profit-incoming rate over a term-rate for the user per unit product.

As one example, user data normalization system 104 (see FIG. 1) calculates product profitability for a case that includes transactional product promotion by calculating an expected product profit rate per unit product (i.e., a general purchase probability across like users and a probability of the user being engaged based on the purchase history of the product and/or similar products plus an adjustment to the base purchase probability given the content of the current cart.

For example, in the case of product promotion to reduce inventory holding, step 206 may include user data normalization system 104 (see FIG. 1) calculating product value as (Quantity in stock)—(cost of good−projected markdowns−holding cost+end of life residual value for expected remaining stock)/(Quantity in stock), where the Quantity in stock is the immediate opportunities at the selling price, the cost of good may include manufacturing, receiving, labor, holding, expiree, etc. cost, projected markdowns include applicable promotions through end of life, the holding cost is the holding cost until the end of life, and the end of life residual value includes donations, write-offs, etc.

As another example, user data normalization system 104 (see FIG. 1) calculates transaction profit in the case of monetized promotion in exchange for user data.

User data normalization system 104 (see FIG. 1) may provide for the velocitization of the value of the data. The intent of such velocitization is to improve the value basis of a single user through the monetization of the user's data, which is collected in a myriad of forms. For example, a bank increases the profit-basis of a simple loan through the leverage of “velocity” as a way to effect revenue potential. The faster a bank can re-loan any portion of a pay-back event on a loan increases the opportunity to re-loan that value. In this model, the ability to velocitize data affects the ability to monetize the normalized insight data.

In one embodiment, step 206 includes a real-time data currency valuation promotion process which includes steps of (1) calculate expected revenue rate and profit rate for the product or service associated with the transaction of interest and for the user data in aggregate; (2) evaluate a base set of current promotion options inside of pre-selected set(s) and select an option from the base set according to pre-selected strategy based on profit, inventory reduction, up-sell, etc.; and (3) update the revenue rate, profit rate per product, product category, user, user segment (i.e., customer segment), or customer-product/service/transaction after a completion of the transaction.

In step 208, user data normalization system 104 (see FIG. 1) determines in real-time that one or more entities are offering respective reward(s) to the user, where each reward is in exchange for the computing device of the user sharing the user data with the entity that is offering the reward. For example, the reward(s) may include a barter, a discount on the cost of purchasing a product or service, loyalty points, or a promotional purchase opportunity.

Each offer for a reward in step 208 is a result of a system of interoperability provided by the value normalization performed in step 206. The value normalization allows the business or other entity to compare the value of user data against the need for the user data, both in a single use and a lifetime value, and immediately provide a value-positioned offering of a reward to the user in step 208, so that the normalized value and the value of the need of the business or other entity is transparent to the user, thereby allowing the user to knowledgeably participate in the negotiation for the sharing of the user data. Improvement of value of the data through velocitization is discussed above.

In step 210, user data normalization system 104 (see FIG. 1) determines respective monetary value(s) of the reward(s) whose offer(s) were determined in step 208 and determines that the normalized value or the cumulative value is greater than or equal to each of the monetary value(s) of the reward(s).

In step 212, based on the normalized value or the cumulative value being greater than or equal to each of the monetary value(s) of the reward(s), user data normalization system 104 (see FIG. 1) dynamically initiates a display of the reward(s) and the normalized value of the user data, where the display is presented on the computing device of the user.

In step 214, user data normalization system 104 (see FIG. 1) receives the user's selection of one of the displayed reward(s), where the selection is sent to user data normalization system 104 (see FIG. 1) via a user interface on the computing device of the user. Alternatively, the user may make a counter-offer that modifies the usage parameters and/or one of the reward(s). The process including the counter-offer is described in more detail after the discussion of step 216.

In step 216, based on the selection of the reward having been received in step 214, user data normalization system 104 (see FIG. 1) (1) receives the user data from the computing device of the user and shares the user data with the entity that is offering the selected reward by sending the user data to the computing device of the entity, and (2) if the reward was selected in step 214, sends the selected reward to a computing device of the user or stores the selected reward so that the computing device of the user may access the stored reward at a later time.

In one embodiment, after step 212 and as an alternate to step 214, user data normalization system 104 (see FIG. 1) receives a counter-offer from the user and subsequently receives an acceptance or a rejection of the counter-offer from the entity. The counter-offer may modify the usage parameters and/or one of the reward(s). If the entity accepts the counter-offer, then the process continues with a variation of step 216 which includes user data normalization system 104 (see FIG. 1) sharing the user data with a computing device of the entity under the conditions specified by the modified usage parameters and/or sending the modified reward to the computing device of the user as remuneration to the user.

The process of FIG. 2 ends at step 218. In one embodiment, the reward(s) discussed above relative to the process of FIG. 2 consist of barter(s).

### EXAMPLES

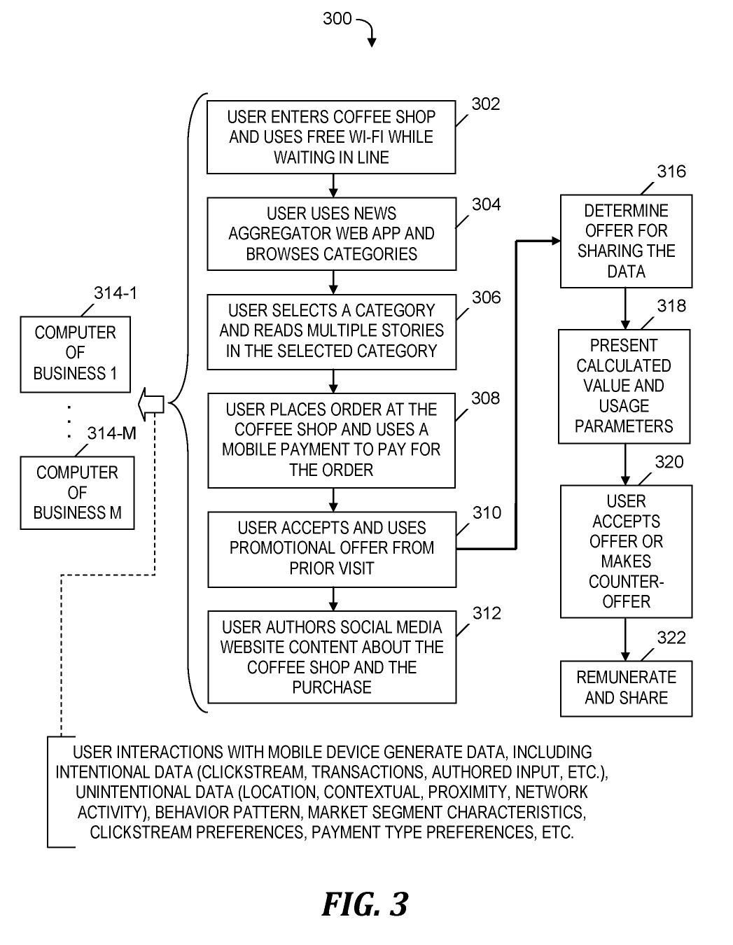

FIG. 3 is an example 300 of determining and normalizing a value of user data and determining an offer whose value is comparable to the normalized value, which utilizes the process of FIG. 2, in accordance with embodiments of the present invention. Example 300 includes a process of a user performing actions and interactions with a mobile device of the user. In step 302 in the aforementioned process, the user enters a coffee shop and while the user waits in line to make a purchase at the coffee shop, the user's mobile device accesses a wireless network via the free Wi-Fi provided by the coffee shop. In step 304, the user's mobile device accesses a news aggregator web application and browses categories of news.

In step 306, the user's mobile device selects one of the categories of news (i.e., “lifestyle”) and displays stories in the selected category for reading by the user.

In step 308, the user places an order at the coffee shop and uses a mobile payment via the user's mobile device to pay for the order.

In step 310, the user's mobile device accepts and utilizes a promotional offer that was accepted by the user during a prior visit to the coffee shop.

In step 312, via the user's mobile device, the user authors social media website content about the coffee shop and the purchase the user made at the coffee shop. After step 312, the user exits the coffee shop.

Each of steps 302, 304, 306, 308, 310, and 312 include an interaction with the user's mobile device, which generates user data that includes (1) data the user intentionally provides (also known as (a.k.a.) intentional data) (e.g., clickstream, transactions, authored input, etc.) (2) data the user unintentionally provides (a.k.a. unintentional data) (e.g., location of the user, contextual data about the user, proximity data, network activity of the user, etc.), (3) behavior pattern of the user, (4) market segment characteristics of the user, (5) clickstream preferences, (6) payment type preferences, etc. The user data includes data in categories that are of interest to Business 1, . . . , Business M which utilize computers 314-1, . . . , 314-M, respectively, where M is an integer greater than or equal to one.

In example 300, in response to step 310, prior to step 316, and in real-time, user data normalization system 104 (see FIG. 1) assesses the value of the user data generated as a result of step 310 and normalizes the value of the data (i.e., performs steps 204 and 206 in FIG. 2).

In step 316, user data normalization system 104 (see FIG. 1) determines that Business 1 is offering a reward to the user for sharing the user data generated as a result of step 310 (i.e., performs step 208 in FIG. 2).

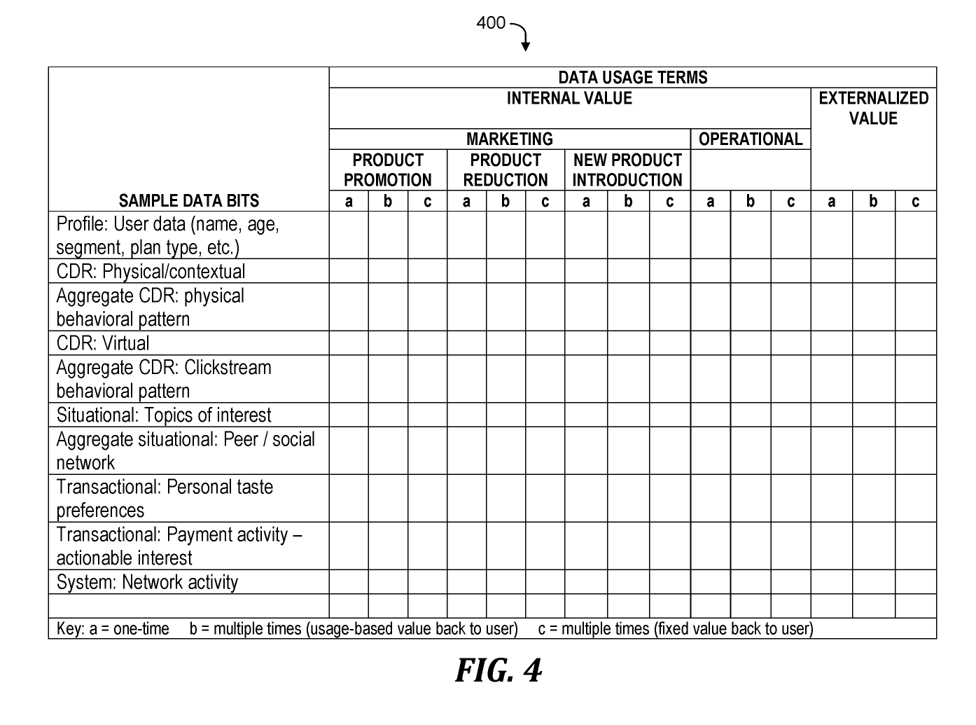

In step 318, user data normalization system 104 (see FIG. 1) determines a value of the user data by retrieving a calculated value corresponding to the category of the user data from a data value matrix 400 (see FIG. 4). In step 318, user data normalization system 104 (see FIG. 1) presents the calculated value and usage parameters to the user via a display in the user's mobile device.

In step 320, the user's mobile device sends the user's acceptance of the offer or the user's counter-offer. In step 322, in response to the user's acceptance of the offer or in response to an acceptance of the user's counter-offer by Business 1 using computer 314-1, user data normalization system 104 (see FIG. 1) sends a remuneration (i.e., the reward) to the user's mobile device or to another computing device of the user. Step 322 also includes user data normalization system 104 (see FIG. 1) sharing the user data with computer 314-1 of Business 1.

FIG. 4 is an example of a data value matrix 400 utilized in the example of FIG. 3, in accordance with embodiments of the present invention. The Sample Data Bits column in data value matrix 400 includes categories of atomic data bits that may be generated by steps 302, 304, 306, 308, 310, and 312 in FIG. 3. The sample data bits include profile data (e.g., name, age, segment, plan type, etc.), CDR data including physical and contextual data about the user, aggregate CDR data including a physical behavioral pattern of the user, CDR data about virtual behavior of the user, aggregate CDR data about virtual behavior of the user (e.g., clickstream behavioral pattern of the user), situational data about the user (e.g., topics in which the user is interested), transactional data including personal taste preferences of the user, system data including network activity of the user's mobile device, aggregate situational data including peer or social network activity of the user, and transactional data including payment activity and actionable interests of the user.

Under the Data Usage Terms section, data value matrix 400 includes sample values (not shown) under the headings “a,” “b,” and “c.” The heading “a” indicates a value of a single use of the user data by an entity. The heading “b” indicates a value of multiple uses of the user data, where the value is usage-based (i.e., based on the number of times the user data is used by the entity). The heading “c” indicates a fixed value for multiple uses of the user data.

The values under the Data Usage Terms section of the data value matrix 400 are categorized by internal value (i.e., used internally by an entity) and externalized value (i.e., re-sold by a first entity to be used by another entity external to the first entity). The Internal Value category is further categorized by Marketing values and Operational values. The Marketing category is further categorized by values for Product Promotion, Product Reduction, or New Product Introduction.

### COMPUTER SYSTEM

FIG. 5 is a block diagram of a computer that is included in the system of FIG. 1 and that implements the process of FIG. 2, in accordance with embodiments of the present invention. Computer 102 is a computer system that generally includes a central processing unit (CPU) 502, a memory 504, an input/output (I/O) interface 506, and a bus 508. Computer 102 is coupled to I/O devices 510 and a computer data storage unit 512. CPU 502 performs computation and control functions of computer 102, including executing instructions included in program code 514 for user data normalization system 104 (see FIG. 1) to perform a method of determining a value of data, where the instructions are executed by CPU 502 via memory 504. CPU 502 may include a single processing unit, or be distributed across one or more processing units in one or more locations (e.g., on a client and server).

Memory 504 includes a known computer readable storage medium, which is described below. In one embodiment, cache memory elements of memory 504 provide temporary storage of at least some program code (e.g., program code 514) in order to reduce the number of times code must be retrieved from bulk storage while instructions of the program code are executed. Moreover, similar to CPU 502, memory 504 may reside at a single physical location, including one or more types of data storage, or be distributed across a plurality of physical systems in various forms. Further, memory 504 can include data distributed across, for example, a local area network (LAN) or a wide area network (WAN).

I/O interface 506 includes any system for exchanging information to or from an external source. I/O devices 510 include any known type of external device, including a display device, keyboard, etc. Bus 508 provides a communication link between each of the components in computer 102, and may include any type of transmission link, including electrical, optical, wireless, etc.

I/O interface 506 also allows computer 102 to store information (e.g., data or program instructions such as program code 514) on and retrieve the information from computer data storage unit 512 or another computer data storage unit (not shown). Computer data storage unit 512 includes a known computer-readable storage medium, which is described below. In one embodiment, computer data storage unit 512 is a non-volatile data storage device, such as a magnetic disk drive (i.e., hard disk drive) or an optical disc drive (e.g., a CD-ROM drive which receives a CD-ROM disk).

Memory 504 and/or storage unit 512 may store computer program code 514 that includes instructions that are executed by CPU 502 via memory 504 to determine a value of data. Although FIG. 5 depicts memory 504 as including program code 514, the present invention contemplates embodiments in which memory 504 does not include all of code 514 simultaneously, but instead at one time includes only a portion of code 514.

Further, memory 504 may include an operating system (not shown) and may include other systems not shown in FIG. 5.

Storage unit 512 and/or one or more other computer data storage units (not shown) that are coupled to computer 102 may store data value matrix 108 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to determining a value of data. Thus, an embodiment of the present invention discloses a process for supporting computer infrastructure, where the process includes providing at least one support service for at least one of integrating, hosting, maintaining and deploying computer-readable code (e.g., program code 514) in a computer system (e.g., computer 102) including one or more processors (e.g., CPU 502), wherein the processor(s) carry out instructions contained in the code causing the computer system to determine a value of data. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of determining a value of data.

While it is understood that program code 514 for determining a value of data may be deployed by manually loading directly in client, server and proxy computers (not shown) via loading a computer-readable storage medium (e.g., computer data storage unit 512), program code 514 may also be automatically or semi-automatically deployed into computer 102 by sending program code 514 to a central server or a group of central servers. Program code 514 is then downloaded into client computers (e.g., computer 102) that will execute program code 514. Alternatively, program code 514 is sent directly to the client computer via e-mail. Program code 514 is then either detached to a directory on the client computer or loaded into a directory on the client computer by a button on the e-mail that executes a program that detaches program code 514 into a directory. Another alternative is to send program code 514 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 514 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of determining a value of data. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 504 and computer data storage unit 512) having computer readable program instructions 514 thereon for causing a processor (e.g., CPU 502) to carry out aspects of the present invention.

The computer readable storage medium can be a tangible device that can retain and store instructions (e.g., program code 514) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 514) described herein can be downloaded to respective computing/processing devices (e.g., computer 102) from a computer readable storage medium or to an external computer or external storage device (e.g., computer data storage unit 512) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 514) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2 and FIG. 4) and/or block diagrams (e.g., FIG. 1 and FIG. 5) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 514).

These computer readable program instructions may be provided to a processor (e.g., CPU 502) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 512) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 514) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of determining a value of data, the method comprising the steps of:
a computer determining that (i) a computing device of a user is performing an action included in a predefined plurality of actions, (ii) in response to a completion of the action, the action generates the data which specifies content authored at least in part by the user or which specifies a preference, a trait, a behavior, or a location of the user, and (iii) the data is in a category of data for which one or more computing devices of one or more entities have sent an indication of interest;
the computer automatically assessing the value of the data;
the computer normalizing the value of the data;
the computer determining that the one or more entities are offering one or more rewards to the user for a sharing of the data;
the computer determining that the one or more rewards have respective one or more monetary values that each equal or exceed the normalized value of the data;
based on the one or more rewards having the one or more monetary values that each equal or exceed the normalized value of the data, the computer initiating a display of the normalized value of the data and the one or more rewards;
the computer receiving a selection of a reward included in the displayed one or more rewards, the selection being received from the computing device of the user, and the selected reward being offered by an entity included in the one or more entities; and
based on the selection of the reward having been received, the computer sharing the data with a computing device of the entity that offered the reward and if the reward was selected, sending the reward to the computing device of the user or another computing device of the user.

2. The method of claim 1, wherein the step of sharing the data includes the computing device of the user providing the data in real-time, and wherein the data is authored by the user and voluntarily submitted by the user to the computing device of the entity, involuntarily provided by the user with or without an awareness of the user about the data being provided, or provided by one or more other people and linked to the user with or without an awareness of the user about the data being provided by the one or more other people and linked to the user.

3. The method of claim 1, wherein the step of normalizing the value of the data includes transforming the assessed value of the data to a monetary value of the data expressed at a level of data bits, and wherein the step of determining that the one or more rewards have the one or more monetary values that each equal or exceed the normalized value of the data includes determining that each of the one or more monetary values equals or exceeds the monetary value of the data expressed at the level of data bits.

4. The method of claim 1, further comprising the steps of:
the computer representing the normalized value of the data as a currency in a virtual medium of exchange; and
the computer presenting to the user an indication that the currency has a value comparable to the one or more monetary values of the one or more rewards, wherein the step of sharing the data is further based on the currency having the value comparable to the one or more monetary values of the one or more rewards.

5. The method of claim 1, wherein the step of assessing the value of the data includes assessing first, second, and third values of the data, wherein the first value of the data is a first monetary value of a single use of the data by the computing device of the entity, wherein the second value of the data is a second monetary value based on an amount of uses in multiple uses of the data by the computing device of the entity, and wherein the third value of the data is a third monetary value which is a fixed value for multiple uses of the data by the computing device of the entity.

6. The method of claim 1, further comprising the steps of:
the computer sending parameters to the computing device of the user, the parameters specifying permitted usage of the data by the entity;
the computer receiving a counter-offer from the computing device of the user that modifies the reward or at least one parameter included in the parameters;
the computer receiving an acceptance the counter-offer; and
in response to the step of receiving the acceptance, if the reward is modified by the counter-offer, the computer performing the step of sending the reward by sending the modified reward, or if the at least one parameter is modified, the computer performing the step of sharing the data by sharing the data based on the modified at least one parameter.

7. The method of claim 1, wherein the step of sharing the data results in a usage of the data internally within the entity or a selling of the data by the entity to another entity.

8. The method of claim 1, wherein the step of determining that the one or more entities are offering the one or more rewards includes determining that the one or more entities are offering one or more barters to the user for the sharing of the data, wherein the step of determining that the one or more rewards have the respective one or more monetary values includes determining that the one or more barters have the respective one or more monetary values that each equal or exceed the normalized value of the data, wherein the step of initiating the display includes initiating a display of the one or more barters, wherein the step of receiving the selection of the reward includes receiving a selection of a barter included in the displayed one or more barters, and wherein the step of sharing the data includes sharing the data with a computing device of an entity that offered the barter.

9. The method of claim 1, further comprising the step of:
providing at least one support service for at least one of creating, integrating, hosting, maintaining, and deploying computer-readable program code in the computer, the program code being executed by a processor of the computer to implement the steps of determining that (i) the computing device of the user is performing the action, (ii) the action generates the data which specifies content authored at least in part by the user or the preference, the trait, the behavior, or the location of the user, and (iii) the data is in the category of data, assessing the value of the data, normalizing the value of the data, determining that the one or more entities are offering one or more rewards, determining that the one or more rewards have respective one or more monetary values that each equal or exceed the normalized value, initiating the display of the normalized value and the one or more rewards, receiving the selection of the reward, sharing the data, and sending the reward if the reward was selected.

10. A computer program product, comprising:
a computer-readable, storage device; and
a computer-readable program code stored in the computer-readable, storage device, the computer-readable program code containing instructions that are executed by a central processing unit (CPU) of a computer system to implement a method of determining a value of data, the method comprising the steps of:
the computer system determining that (i) a computing device of a user is performing an action included in a predefined plurality of actions, (ii) in response to a completion of the action, the action generates the data which specifies content authored at least in part by the user or which specifies, a preference, a trait, a behavior, or a location of the user, and (iii) the data is in a category of data for which one or more computing devices of one or more entities have sent an indication of interest;
the computer system automatically assessing the value of the data;
the computer system normalizing the value of the data;
the computer system determining that the one or more entities are offering one or more rewards to the user for a sharing of the data;
the computer system determining that the one or more rewards have respective one or more monetary values that each equal or exceed the normalized value of the data;
based on the one or more rewards having the one or more monetary values that each equal or exceed the normalized value of the data, the computer system initiating a display of the normalized value of the data and the one or more rewards;
the computer system receiving a selection of a reward included in the displayed one or more rewards, the selection being received from the computing device of the user, and the selected reward being offered by an entity included in the one or more entities; and
based on the selection of the reward having been received, the computer system sharing the data with a computing device of the entity that offered the reward and if the reward was selected, sending the reward to the computing device of the user or another computing device of the user.

11. The computer program product of claim 10, wherein the step of sharing the data includes the computing device of the user providing the data in real-time, and wherein the data is authored by the user and voluntarily submitted by the user to the computing device of the entity, involuntarily provided by the user with or without an awareness of the user about the data being provided, or provided by one or more other people and linked to the user with or without an awareness of the user about the data being provided by the one or more other people and linked to the user.

12. The computer program product of claim 10, wherein the step of normalizing the value of the data includes transforming the assessed value of the data to a monetary value of the data expressed at a level of data bits, and wherein the step of determining that the one or more rewards have the one or more monetary values that each equal or exceed the normalized value of the data includes determining that each of the one or more monetary values equals or exceeds the monetary value of the data expressed at the level of data bits.

13. The computer program product of claim 10, wherein the method further comprises the steps of:
the computer system representing the normalized value of the data as a currency in a virtual medium of exchange; and
the computer system presenting to the user an indication that the currency has a value comparable to the one or more monetary values of the one or more rewards, wherein the step of sharing the data is further based on the currency having the value comparable to the one or more monetary values of the one or more rewards.

14. The computer program product of claim 10, wherein the step of assessing the value of the data includes assessing first, second, and third values of the data, wherein the first value of the data is a first monetary value of a single use of the data by the computing device of the entity, wherein the second value of the data is a second monetary value based on an amount of uses in multiple uses of the data by the computing device of the entity, and wherein the third value of the data is a third monetary value which is a fixed value for multiple uses of the data by the computing device of the entity.

15. The computer program product of claim 10, wherein the method further comprises the steps of:
the computer system sending parameters to the computing device of the user, the parameters specifying permitted usage of the data by the entity;
the computer system receiving a counter-offer from the computing device of the user that modifies the reward or at least one parameter included in the parameters;
the computer system receiving an acceptance the counter-offer; and
in response to the step of receiving the acceptance, if the reward is modified by the counter-offer, the computer system performing the step of sending the reward by sending the modified reward, or if the at least one parameter is modified, the computer system performing the step of sharing the data by sharing the data based on the modified at least one parameter.

16. A computer system comprising:
a central processing unit (CPU);
a memory coupled to the CPU; and
a computer readable storage device coupled to the CPU, the computer readable storage device containing instructions that are executed by the CPU via the memory to implement a method of determining a value of data, the method comprising the steps of:
the computer system determining that (i) a computing device of a user is performing an action included in a predefined plurality of actions, (ii) in response to a completion of the action, the action generates the data which specifies content authored at least in part by the user or which specifies, a preference, a trait, a behavior, or a location of the user, and (iii) the data is in a category of data for which one or more computing devices of one or more entities have sent an indication of interest;
the computer system automatically assessing the value of the data;
the computer system normalizing the value of the data;
the computer system determining that the one or more entities are offering one or more rewards to the user for a sharing of the data;
the computer system determining that the one or more rewards have respective one or more monetary values that each equals or exceeds the normalized value of the data;
based on the one or more rewards having the one or more monetary values that each equals or exceeds the normalized value of the data, the computer system initiating a display of the normalized value of the data and the one or more rewards;
the computer system receiving a selection of a reward included, respectively, in the displayed one or more rewards, the selection being received from the computing device of the user, and the selected reward being offered by an entity included in the one or more entities; and
based on the selection of the reward having been received, the computer system sharing the data with a computing device of the entity that offered the reward and if the reward was selected, sending the reward to the computing device of the user or another computing device of the user.

17. The computer system of claim 16, wherein the step of sharing the data includes the computing device of the user providing the data in real-time, and wherein the data is authored by the user and voluntarily submitted by the user to the computing device of the entity, involuntarily provided by the user with or without an awareness of the user about the data being provided, or provided by one or more other people and linked to the user with or without an awareness of the user about the data being provided by the one or more other people and linked to the user.

18. The computer system of claim 16, wherein the step of normalizing the value of the data includes transforming the assessed value of the data to a monetary value of the data expressed at a level of data bits, and wherein the step of determining that the one or more rewards have the one or more monetary values that each equals or exceeds the normalized value of the data includes determining that each of the one or more monetary values equals or exceeds the monetary value of the data expressed at the level of data bits.

19. The computer system of claim 16, wherein the method further comprises the steps of:
the computer system representing the normalized value of the data as a currency in a virtual medium of exchange; and
the computer system presenting to the user an indication that the currency has a value comparable to the one or more monetary values of the one or more rewards, wherein the step of sharing the data is further based on the currency having the value comparable to the one or more monetary values of the one or more rewards.

20. The computer system of claim 16, wherein the step of assessing the value of the data includes assessing first, second, and third values of the data, wherein the first value of the data is a first monetary value of a single use of the data by the computing device of the entity, wherein the second value of the data is a second monetary value based on an amount of uses in multiple uses of the data by the computing device of the entity, and wherein the third value of the data is a third monetary value which is a fixed value for multiple uses of the data by the computing device of the entity.
